(19) United States
(12) Patent Application Publication
(10) Pub. No.: US 2024/0066992 A1
(43) Pub. Date: Feb. 29, 2024

(54) CHARGING SYSTEM AND CHARGER THEREFOR

(71) Applicants: HYUNDAI MOTOR COMPANY, SEOUL (KR); KIA CORPORATION, SEOUL (KR)

(72) Inventor: Taek Hyun JUNG, Seoul (KR)

(21) Appl. No.: 18/101,839

(22) Filed: Jan. 26, 2023

(30) Foreign Application Priority Data
Aug. 31, 2022 (KR) 10-2022-0109974

(51) Int. Cl. B60L 3/00; B60L 53/10; B60L 55/00; B60L 58/12; B60R 16/023; H02J 7/00

(52) U.S. Cl. CPC B60L 3/0023; B60L 53/10; B60L 55/00; B60L 58/12; B60R 16/0238; H02J 7/0024; B60L 2210/30

(57) ABSTRACT

Disclosed are a charging system including a junction box having a first terminal connected to a system power supply, a second terminal connected to an external load, a third terminal connected to an external on-board charger, and a switch unit configured to selectively connect at least two of the first to third terminals, and a controller configured to control a connection state of the switch unit on the basis of whether power failure occurs in the system power supply and an operation mode of the external on-board charger, and a charger for the charging system.

### CROSS-REFERENCE TO RELATED APPLICATION

This application is based on and claims priority under 35 U.S.C. 119 to Korean Patent Application No. 10-2022-0109974, filed on Aug. 31, 2022, in the Korean Intellectual Property Office, the disclosure of which is herein incorporated reference in its entirety.

### TECHNICAL FIELD

The present disclosure relates to a charging system in which a system power supply, an external load, and an external on-board charger are connected, and charging between the system power supply, the external load, and the external on-board charger is performed on the basis of whether power failure occurs in the system power supply and the operation mode of the external on-board charger, and a charger therefor.

### BACKGROUND

With recent increasing interest in the environment, eco-friendly vehicles having an electric motor as a power source have been increasing in number. An eco-friendly vehicle is also referred to as an electric vehicle, and a typical example may include an electric vehicle (EV) or a hybrid electric vehicle (HEV). These electric vehicles are provided with a battery and operate by the energy stored in the battery.

In addition, as the battery capacity of recent electric vehicles is continuously increasing, methods for using a vehicle itself as a power supply source, such as an energy storage system (ESS), to efficiently use power have been proposed. One example of such methods is V2X (Vehicle-to-Everything) technology. V2X technology may be classified into V2G (Vehicle-to-Grid), V2L (Vehicle-to-Load), V2H (Vehicle-to-Home), V2V (Vehicle-to-Vehicle), and the like depending on a target to which energy is supplied. Thereamong, V2G is technology for directly supplying electric energy stored in a battery of an electric vehicle to a power system and can achieve effects such as stabilization of system power quality and generation of profits through selling the electric energy stored into the battery. In addition, V2H is technology for supplying electric energy stored in a battery of an electric vehicle to a home. In this case, a battery of an electric vehicle may serve as a backup power source in case of power failure.

For application of such V2X technology, an electric vehicle may be provided with an on-board charger (OBC). Unlike a conventional unidirectional charger, the on-board charger can receive electric energy from the outside to charge a battery of a vehicle and also supply the electric energy stored in the battery of the vehicle to the outside.

Meanwhile, a vehicle is connected to the existing power supply as a current source during V2G operation, whereas a vehicle may serve as an independent voltage source and supply electric energy to household devices during V2H operation, and thus control for power supply needs to be performed differently depending on a target.

### SUMMARY

Therefore, the present disclosure has been made in view of the above problems, and it is an object of the present disclosure to provide a charging system for power supply and charging of a system power supply, an external load, and an external on-board charger on the basis of whether power failure occurs in the system power supply and an operation mode of the external on-board charger, and a charger therefor.

The technical issues to be achieved in the present disclosure are not limited to the technical issues mentioned above, and other technical issues which are not mentioned will be clearly understood by those of ordinary skill in the art to which the present disclosure belongs from the description below.

In accordance with the present disclosure, the above and other objects can be accomplished by the provision of a charger including a junction box having a first terminal connected to a system Power supply, a second terminal connected to an external load, a third terminal connected to an external on-board charger, and a switch unit configured to selectively connect at least two of the first to third terminals, and a controller configured to control a connection state of the switch unit on the basis of whether power failure occurs in the system power supply and an operation mode of the external on-board charger.

For example, the junction box may receive AC power from the system power supply through the first terminal and supply the AC power to at least one of the external load or the external on-board charger on the basis of the connection state of the switch unit, or receive AC power from the external on-board charger through the third terminal and supply the AC power to at least one of the system power supply or the external load on the basis of the connection state of the switch unit.

For example, the charger may further include a communication device configured to communicate with an external charging controller connected to the external on-board charger, wherein the controller may receive an operation mode of the external on-board charger or a connection state change request corresponding to the operation mode from the external charging controller through the communication device, or request that the external charging controller change the operation mode of the external on-board charger.

For example, the controller may control the connection state of the switch unit such that the second terminal and the third terminal are connected to each other when power failure occurs in the system power supply.

For example, the controller may control the connection state of the switch unit such that connections of the first to third terminals are all released when power failure occurs in the system power supply, and additionally control the connection state of the switch unit such that the second terminal and the third terminal are connected when the operation mode of the external on-board charger is a mode for supplying power to the external load.

For example, the controller may additionally control the connection state of the switch unit such that the first terminal and the second terminal are connected when the operation mode of the external on-board charger is not the mode for supplying power to the external load.

For example, the controller may request that the external charging controller change the operation mode through the communication device such that the external on-board charger stops power supply when the operation mode of the external on-board charger is a mode for supplying power to the system power supply.

For example, the controller may request that the external charging controller change the operation mode through the communication device such that the external on-board charger starts power supply when the second terminal and the third terminal are connected by controlling the connection state of the switch unit.

For example, the controller may control the connection state of the switch unit such that the first terminal and the second terminal are connected at the time of restoring power failure of the system power supply.

For example, the controller may control the connection state of the switch unit such that the first terminal and the third terminal are connected when the operation mode of the external on-board charger is a mode for supplying power to the system power supply or a mode for receiving power from the system power supply at the time of restoring the power failure of the system power supply.

For example, the controller may control the connection state of the switch unit such that the first terminal and the third terminal are disconnected from each other when the operation mode of the external on-board charger does not correspond to any one of the mode for supplying power to the system power supply and the mode for receiving power from the system power supply during power failure restoration.

For example, the controller may request that the external charging controller change the operation mode through the communication device such that the external on-board charger stops power supply when the operation mode of the external on-board charger is a mode for supplying power to the external load at the time of restoring the power failure of the system power supply.

For example, the switch unit may include a first switch and a second switch, and one end of the first switch may be connected to the first terminal, the other end may be connected to one end of the second switch, the other end of the second switch may be connected to the third terminal, and the second terminal may be connected between the other end of the first switch and one end of the second switch.

For example, the charger may further include a converter configured to convert AC power supplied through at least one of the first terminal or the third terminal into DC power, and a battery configured to store the DC power converted through the converter, wherein the junction box may further include a fourth terminal connected to the converter and selectively connect at least two of the first to fourth terminals.

In accordance with another aspect of the present disclosure, there is provided a charging system including an external on-board charger configured to supply power to a system power supply or to receive power from the system power supply, an external charging controller configured to control the external on-board charger, and a charger including a junction box having a first terminal connected to a system power supply, a second terminal connected to an external load, a third terminal connected to the external on-board charger, and a switch unit configured to selectively connect at least two of the first to third terminals, and a controller configured to control a connection state of the switch unit on the basis of whether power failure occurs in the system power supply and an operation mode of the external on-board charger.

For example, the charger may further include a communication device configured to communicate with the external charging controller, wherein the controller may receive an operation mode of the external on-board charger from the external charging controller through the communication device, or request that the external charging controller change the operation mode of the external on-board charger.

For example, the external charging controller may determine at least one of whether the external on-board charger is able to supply power to the external load, whether the external on-board charger is able to supply power to the system power supply, or whether the external on-board charger is able to receive power from the system power supply when preset conditions are satisfied, and control the operation mode of the external on-board charger to be changed on the basis of a determination result.

For example, when the operation mode of the external on-board charger is ganged, the external charging controller may transmit the changed operation mode of the external on-board charger to the controller through the communication device or request switch connection state control corresponding to the changed operation mode.

For example, the external charging controller may determine whether power is able to be supplied to the external load or the system power supply on the basis of at least one of a state of charge (SOC) of an external battery connected to the external on-board charger or whether the external on-board charger normally operates.

For example, when the operation mode is a mode for supplying power to the system power supply or a mode for receiving power from the system power supply, the external charging controller may perform output current and phase control through the external on-board charger to correspond to the system power supply, and when the operation mode is a mode for supplying power to the external load, the external charging controller may perform voltage and frequency control through the external on-board charger to correspond to the external load.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing a configuration of a charger according to an embodiment of the present disclosure;

FIG. 2 is a diagram showing a configuration of a charging system according to an embodiment of the present disclosure;

FIG. 3 is a diagram for describing an operation process of the charger when power failure occurs in a system power supply according to an embodiment of the present disclosure;

FIG. 4 is a diagram for describing an operation process the charger when power failure of the system power supply is restored according to an embodiment of the present disclosure;

FIG. 5A is a diagram for describing an operation process of the charging system according to an embodiment of the present disclosure; and

FIG. 5B is a diagram for describing an operation process of the charging system according to an embodiment of the present disclosure.

### DETAILED DESCRIPTION

Specific structural or functional descriptions of embodiments of the present disclosure disclosed in the present specification or application are only exemplified for the purpose of describing the embodiments according to the present disclosure, and the embodiments according to the present disclosure are implemented in various forms and should not be construed as being limited to the embodiments described in this specification or application.

Since the embodiments according to the present disclosure may be changed in various ways and may take various forms, specific embodiments will be illustrated in the drawings and described in detail in the present specification or application. However, this is not intended to limit the embodiments according to the concept of the present disclosure to a specific disclosed form and should be understood to include all modifications, equivalents and substitutes included in the spirit and scope of the present disclosure.

All terms including technical or scientific terms have the same meanings as generally understood by a person having ordinary skill in the art to which the present disclosure pertains unless mentioned otherwise. Generally used terms, such as terms defined in a dictionary, should be interpreted to coincide with meanings of the related art from the context. Unless differently defined in the present disclosure, such terms should not be interpreted in an ideal or excessively formal manner.

Hereinafter, embodiments disclosed in the present specification will be described in detail with reference to the accompanying drawings, but the same or similar components are assigned the same reference numerals regardless of reference numerals and redundant descriptions thereof will be omitted.

The suffixes “module” and “part” of elements herein are used for convenience of description and thus can be used interchangeably and do not have any distinguishable meanings or functions.

In the following description of the embodiments disclosed in the present specification, a detailed description of known functions and configurations incorporated herein will be omitted when it may obscure the subject matter of the present disclosure. In addition, the accompanying drawings are only for easy understanding of the embodiments disclosed in the present specification, do not limit the technical spirit disclosed herein, and include all changes, equivalents and substitutes included in the spirit and scope of the present disclosure.

The terms “first” and/or “second” are used to describe various components, but such components are not limited by these terms. The terms are used to discriminate one component from another component.

When a component is “coupled” or “connected” to another component, it should be understood that a third component may be present between the two components although the component may be directly coupled or connected to the other component. When a component is “directly coupled” or “directly connected” to another component, it should be understood that no element is present between the two components.

An element described in the singular form is intended to include a plurality of elements unless the context clearly indicates otherwise.

In the present specification, it will be further understood that the term “comprise” or the term “include” specifies the presence of a stated feature, figure, step, operation, component, part or combination thereof, but does not preclude the presence or addition of one or more other features, figures, steps, operations, components, or combinations thereof.

In addition, a unit or a control unit such as a motor control unit (MCU) is only a term widely used to name a controller that controls a specific vehicle function and does not mean a generic functional unit.

A controller may include a communication device that communicates with other controllers or sensors to control functions thereof, a memory that stores an operating system or logic commands and input/output information, and one or more processors that perform determination, operation, and decision necessary to control the functions.

In one embodiment of the present disclosure, the connection state of a switch unit 115 is controlled on the basis of whether power failure occurs in a system power supply 10 and the operation mode of an external on-board charger 210, and thus an appropriate power supply route is applied according to each situation.

Here, the external on-board charger 210 means a charger provided in an electric vehicle, but is not necessarily limited thereto. In addition, the power supply route herein includes V2G and V2H, but is not necessarily limited to a form in which power is supplied from a vehicle.

Prior to description of a charging system according to embodiments of the present disclosure, the structure of a charger applicable to the embodiments will be described first.

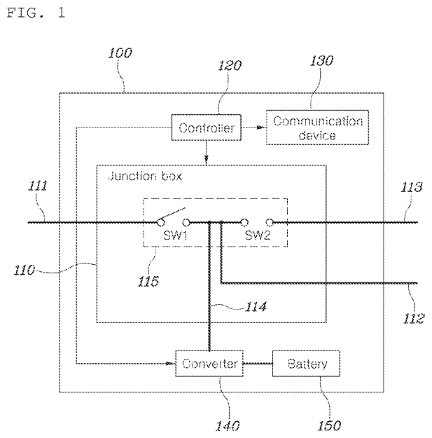

FIG. 1 is a diagram showing a configuration of a charger according to an embodiment of the present disclosure.

Referring to FIG. 1, the charger 100 according to an embodiment is connected to a power supply source and a power supply target. Although the power supply source and the power supply target may be separate components, one component may supply power and also receive power. Accordingly, the charger 100 is also assumed to be a bidirectional charger capable of supplying power in one direction and in the reverse direction even in a fixed connection state. The charger 100 according to an embodiment may include a junction box 110, a controller 120, a communication device 130, a converter 140, and a battery 150. FIG. 1 shows components related to the embodiment of the present disclosure, and the actual implementation of the charger may include more or fewer components than these components. Hereinafter, each component will be described in further detail.

First, the junction box 110 includes a wiring device for installation and maintenance of electric wiring and may be provided for wiring a power line for power supply in an embodiment of the present disclosure. The junction box 110 may include a first terminal 111, a second terminal 112, a third terminal 113, and a fourth terminal 114, and a power supply source or a supply target is connected to each terminal.

In addition, the junction box 110 may include a switch unit 115 selectively connecting at least two of the first to fourth terminals 111 to 114. The switch unit 115 may include first switch SW1 and a second switch SW2. Here, each of the switches SW1 and SW2 may include a plurality of switches that is integrally controlled. The first switch SW1 and the second switch SW2 may be individually controlled and thus the switch unit 115 may have a plurality of connection states.

More specifically, one end of the first switch SW1 may be connected to the first terminal 111, and the other end of the first switch SW1 may be connected to one end of the second switch SW2. In this case, the other end of the second switch SW2 may be connected to the third terminal 113, and the second terminal 112 and the fourth terminal 114 may be connected between the other end of the first switch SW1 and one end of the second switch SW2. When the switch unit 115 is configured in this manner, all of the first to fourth terminals 111 to 114 are connected when both the first switch SW1 and the second switch SW2 are turned on, and the first terminal 111 may be connected to the second terminal 112 and the fourth terminal 114 when only the first switch SW1 is turned on. The third terminal 113 may be connected to the second terminal 112 and the fourth terminal 114 when only the second switch SW2 is turned on, and connections of the first to fourth terminals 111 to 114 are released when both the first switch SW1 and the second switch SW2 are turned off. Such a connection state of the switch unit 115 may be controlled through a control signal of the controller 120 and the operation of a fuse or a relay corresponding thereto.

In one embodiment, the junction box 110 may receive AC power through the first terminal 111 and supply the AC power through at least one of the second terminal 112 or the third terminal 113 or may receive the AC power through the third terminal 113 and supply the AC power through at least one of the first terminal 111 or the second terminal 112. That is, the charger 100 according to one embodiment may be an alternating current (AC) charger, and thus there is no need to provide an inverter, a DC charging cable, and a connector for converting DC power into AC power in the charger 100 since the charger 100 is implemented as an AC charger. Accordingly, it is possible to obtain an advantage in terms of cost, size, noise, and usability as compared to a direct current (DC) charger, and thus it is possible to provide the charger 100 and a charging system suitable for installation and use at home. In this case, the external on-board charger 210 may charge the external battery 230 by converting received AC power into DC power.

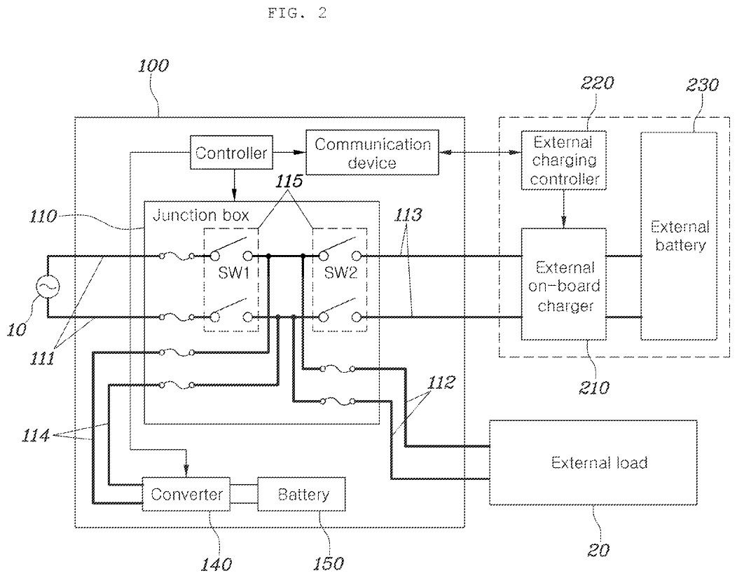

The controller 120 controls the connection state of the switch unit 115 on the basis of whether power failure occurs in the system power supply 10 and the operation mode of the external on-board charger 210. In an embodiment, the controller 120 may be implemented as a microcontroller unit (MCU). In addition, the charger 100 according to an embodiment may further include the communication device 130. The communication device 130 may communicate with an external charging controller 220 connected to the external on-board charger 210, and the like, and the controller 120 may receive an operation mode of the external on-board charger 210 from the external charging controller 220 through the communication device 130 or request that the external charging controller 220 change the operation state of the external on-board charger 210. Meanwhile, according to an embodiment, the communication device 130 may be implemented as a supply equipment communication controller (SECC). The controller 120 and the communication device 130 will be described later in more detail with reference to FIG. 2.

The charger 100 according to an embodiment may further include the converter 140 and the battery 150. The converter 140 may be connected to the first to third terminals 111 to 113 through the fourth terminal 114 and may convert AC power supplied through at least one of the first terminal 111 or the third terminal 113 into DC power, and the battery 150 may store the DC power converted through the converter 140. In one embodiment, the converter 140 may be implemented as a regulator and may include a component that executes a function of converting AC power into DC power regardless of the name thereof. The battery 150 supplies stored power such that the charger 100 can operate even when power supply to the charger 100 is stopped due to power failure of the system power supply 10. Further, the battery 150 may serve to supply power to the outside through the first to third terminals 111 to 113 depending on the capacity thereof.

Hereinafter, an operation of a charging system through the charger 100 will be described with reference to FIG. 2 based on the above description of the charger 100.

FIG. 2 is a diagram showing a configuration of a charging system according to an embodiment of the present disclosure.

Referring to FIG. 2, the charging system according to an embodiment may include a system power supply 10, an external load 20, the charger 100, the external on-board charger 210, the external charging controller 220, and the external battery 230. FIG. 2 mainly shows components related to an embodiment of the present disclosure, and the actual implementation of the charging system may include more or fewer components than these components.

First, the system power supply 10 serves as a main power supply source for the external load 20 and the external battery 230. However, in the embodiments of the present disclosure, the system power supply 10 may be charged by receiving power stored in the external battery 230 depending on the connection state of the switch unit 115 of the charger 100 and the operation mode of the external on-board charger 210 (e.g., V2G). The external load 20 receives power from the system power supply 10 and may receive power stored in the external battery 230 depending on the connection state of the switch unit 115 of the charger 100 and the operation mode of the external on-board charger 210. Here, the external load 20 may include various power supply targets such as a chargeable electronic device and a separate electric vehicle as well as an electric load at home, and when the external battery 230 is provided in an electric vehicle, a power supply route such as V2H, V2I, or V2V may be formed. The system power supply 10 and the external load 20 as described above may be connected to the first terminal 111 and the second terminal 112 of the junction box 110.

The charger 100 is connected to the system power supply 10, the external load 20, and the external on-board charger 210 through the junction box 110. In this case, at least one system power supply 10, at least one external load 20, and at least one external on-board charger 210 may be provided, and, a plurality of connections may be formed between the components 10, 20, and 210 and the junction box 110. More specifically, the junction box 110 of the charger 100 may include the first terminal 111 connected to the system power supply 10, the second terminal 112 connected to the external load 20, the third terminal connected to the external on-board charger 200, and the fourth terminal connected to the converter 140.

In addition, some or all of the first to fourth terminals 111 to 114 may be connected or disconnected through the controller 120 depending on the connection state of the switch unit 115 provided in the junction box 110 in the charger 10. Accordingly, the connection state between the system power supply 10, the external load 20, the external on-board charger 210, and the converter 140 connected to the terminals 111 to 114 is also determined. Therefore, it is possible to properly connect a power supply source and a supply target or release a connection state depending on a situation according to whether power failure occurs in the system power supply 10 or the operation mode of the external on-board charger 210.

The controller 120 of the charger 100 controls the connection state of the switch unit 115 on the basis of whether power failure occurs in the system power supply 10 and the operation mode of the external on-board charger 210.

Here, power failure in the system power supply 10 may mean a state in which power supply of the system power supply 10 is stopped due to a fault in the system power supply 10 itself, disconnection of a power transmission line, or the like. The system power supply 10 is a main power source of the external battery 230 connected to the external load 20 and the external on-board charger 210, and in particular, the system power supply 10 is always connected to the external load 20 such as home electronic devices to supply most of requested power in a general situation. Therefore, when power failure occurs in the system power supply 10, it is necessary to receive power through a separate supply source, and in this case, the external battery 230 such as a battery of an electric vehicle may serve as a supply source. In an embodiment of the present disclosure, the controller 120 may control the connection state of the switch unit 115 on the basis of whether power failure occurs in the system power supply 10 such that the power of the external battery 230 can be supplied to the external load 20 through the external on-board charger 210. To this end, the controller 120 may detect whether power failure occurs in the system power supply 10 by sensing a voltage or current input through the first terminal 111 of the junction box 110.

Meanwhile, the operation mode of the external on-board charger 210 may include a power supply mode, an operation stop mode, a charging mode, and the like. In particular, in the embodiments of the present disclosure, the operation mode may include a mode for supplying power to the system power supply 10, a mode for receiving power from the system power supply 10, a mode for supplying power to the external load 20, and the like according to a relationship with the system power supply 10 or the external load 20. Here, when the external on-board charger 210 operates in the mode for supplying power to the system power supply 10 and the mode for receiving power from the system power supply 10, the external charging controller 220 performs output current and phase control through the external on-board charger 210 such that supplied power corresponds to the system power supply 10 for synchronization with the system power supply. When the external on-board charger 210 operates in the mode for supplying power to the external load 20, the external charging controller 220 performs voltage and frequency control through the external on-board charger 210 such that supplied power corresponds to the external load 20. The power of the external battery 230 is connected as a current source when the external on-board charger 210 supplies power to or receives power from the system power supply 10, whereas the power of the external battery 230 serves as a voltage source when the external on-board charger 210 supplies power to the external load 20, and thus there is a difference in the control of the external on-board charger 210 depending on a supply target. In the present disclosure, the controller 120 may control the connection state of the switch unit 115 on the basis of the operation mode of the external on-board charger 210 as described above and maintain or change the connection state of the system power supply 10, the external load 20, and the external on-board charger 210 according thereto to enable switching between power supply routes, such as from V2G to V2H or from V2H to V2G. To this end, the controller 120 may receive the operation mode of the external on-board charger 210 from the external charging controller 220 through the communication device 130 or receive a switch unit connection state control request corresponding to the operation mode to recognize the operation mode of the external on-board charger 210.

The external on-board charger 210 may be connected to the external battery 230 to supply power stored in the external battery 230 to the system power supply 10 or the external load 20, or receive power from the system power supply 10 and charge external battery 230. The external on-board charger 210 may operate in different operation modes depending on whether power is supplied or received and a power supply target, as described above, and the operation mode is controlled by the external charging controller 220 connected to the external on-board charger 210.

The external charging controller 220 may control the external on-board charger 210, transmit the operation mode of the external on-board charger 210 to the controller 120 through the communication device 130 of the charger 100 or request switch unit connection state control corresponding thereto, and receive an operation mode change request from the controller 120.

In addition, the external charging controller 220 may determine whether the external on-board charger 210 can supply power to the system power supply 10 or the external load 20 and whether the external on-board charger 210 can receive power supplied from the system power supply 10 when preset conditions are satisfied, and change the operation mode of the external on-board charger 210 on the basis of the determination result. Here, the preset conditions may be satisfied in a case where an operation mode change request is received from the controller 120 through the communication device 130, a case where the switch unit 115 has a specific connection state, a case where a communication connection with the communication device 130 is established, etc. For example, the external charging controller 220 may determine whether the external on-board charger 120 can supply power to the external load 20 when the connection state of the switch unit 115 causes the first terminal 111 to be disconnected from the second terminal 112 and the third terminal 113. If it is determined that the external on-board charger 210 can supply power to the external load 20, the operation mode of the external on-board charger 210 may be changed to the mode for supplying power to the external load 20.

In addition, whether power can be supplied may be determined on the basis of at least one of the state of charge (SOC) of the external battery 230 or whether the external on-board charger 210 normally operates. When the external battery 230 is provided in an electric vehicle, a reserved departure/arrival time of the vehicle may be additionally considered. For example, when the SOC of the battery is less than a preset value, the external on-board charger 210 is in a malfunctioning state, a reserved departure time of the vehicle is less than a preset time, and the like, the external charging controller 220 may determine that the external on-board charger 210 cannot supply power to the system power supply 10 or the external load 20.

In addition, when the operation mode of the external on-board charger 210 is changed, the external charging controller 220 may transmit the changed operation mode of the external on-board charger 210 to the controller 120 through the communication device 130 or request switch unit connection state control corresponding thereto.

In addition, when the operation mode of the external on-board charger 210 is the mode for supplying power to the system power supply 10 or the mode for receiving power from the system power supply 10, the external charging controller 220 may perform output current and phase control through the external on-board charger 210 to correspond to the system power supply 10. When the operation mode is the mode for supplying power to the external load 20, the external charging controller 220 may perform voltage and frequency control through the external on-board charger 210 to correspond to the external load 20.

In one embodiment of the present disclosure, the external on-board charger 210, the external charging controller 220 and the external battery 230 may be implemented as components of an electric vehicle, and in this case, the external charging controller 220 may be implemented as a vehicle charge management system (VCMS).

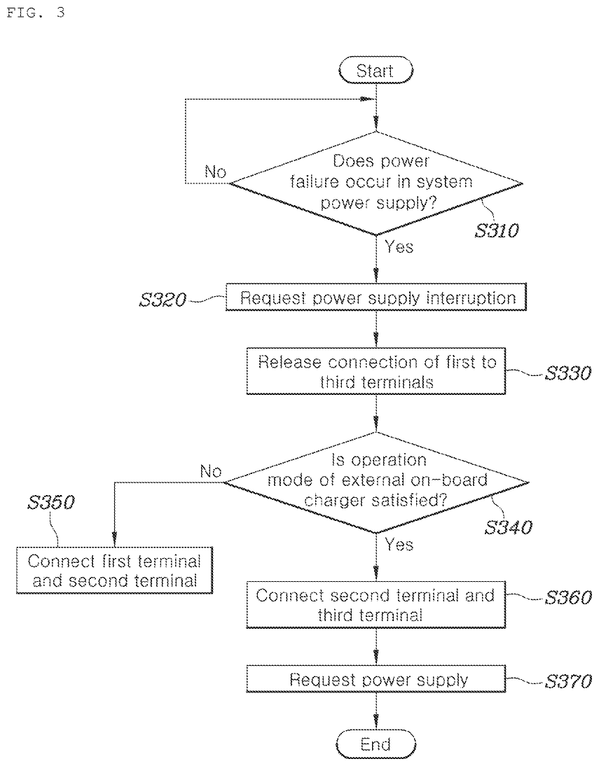

FIGS. 1 and 2 illustrate the configurations and functions of the charging system and the charger 100 therefor in the embodiments of the present disclosure, and a detailed control process will be described below with reference to FIGS. 3 to 5B.

FIG. 3 is a diagram for describing an operation process of the charger when power failure occurs in the system power supply according to an embodiment of the present disclosure.

Referring to FIG. 3, first, the controller 120 detects whether power failure occurs in the system power supply 10 (S310). In the event of power failure in the system power supply 10 (Yes in S310), the controller 120 may request that the external charging controller 220 stop power supply through the communication device 130, and in this case, may also transmit information on the occurrence of the power failure (S320). In addition, the controller 120 may control the connection state of the switch unit 115 such that the second terminal 112 and the third terminal 113 are connected when power failure occurs in the system power supply 10. In this case, the controller 120 may control the connection state of the switch unit 115 such that the first terminal 111 is disconnected from the second terminal 112 and the third terminal 113, and in the event of power failure of the system power supply 10, the controller 120 may control the connection state of the switch unit 115 such that connection of the first to third terminals 111 to 113 is released (S330). As the connection of the first to third terminals 111 to 113 is released, connections between the system power supply 10, the external load 20, and the external on-board charger 210 are cut off. Accordingly, power is supplied to the charger 100 even in the event of power failure of the system power supply 10 such that the independent operation phenomenon does not occur, thereby preventing electric shock accidents, damage to the external load 20 and the external on-board charger 210, and the like. Furthermore, it is possible to satisfy the standard for being connected to the system power supply 10.

In a state in which the connection of the first to third terminals 111 to 113 is released, the controller 120 may additionally control the connection state of the switch unit 115 such that the second terminal 112 and the third terminal 113 are connected (S360) if the operation mode of the external on-board charger 210 is the mode for supplying power to the external load 20 (Yes in S340). When the second terminal 112 and the third terminal 113 are connected to each other, the external on-board charger 210 and the external load 20 are connected, and thus power can be supplied to the external load 20 through the external on-board charger 210. Thereafter, the controller 120 may request that the external charging controller 220 change the operation mode through the communication device 130 such that the external on-board charger 210 starts power supply to the external load 20 (S370). On the other hand, when the operation mode of the external on-board charger 210 is not the mode for supplying power to the external load 20 (No in S340), the controller 120 may control the switch unit 115 to connect the first terminal 111 and the second terminal 112 (S350) such that power can be supplied to the external load 20 when power failure of the system power supply 10 is restored.

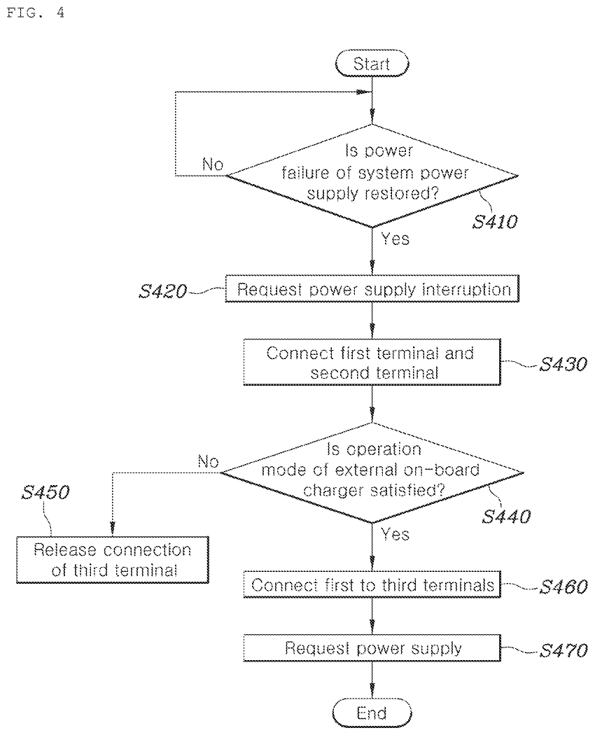

FIG. 3 is a diagram for describing the operation process of the charger in case of power failure of the system power supply. The operation process when power failure of the system power supply is restored will be described below with reference to FIG. 4.

FIG. 4 is a diagram for describing the operation process of the charger when power failure of the system power supply is restored according to an embodiment of the present disclosure.

Referring to FIG. 4, the controller 120 may transmit power failure restoration information to the external charging controller 220 through the communication device 130 when power failure of the system power supply 10 is restored (Yes in S410) and request power supply interruption (S420). Further, the controller 120 may control the connection state of the switch unit 115 such that the first terminal 111 and the second terminal 112 are connected (S430).

When the first terminal 111 and the second terminal 112 are connected, the system power supply 10 and the external load 20 are connected and thus the external load 20 can receive power from the system power supply 10. Then, the controller 120 may control the connection state of the switch unit 115 such that all of the first to third terminals 111 to 113 are connected (S460) when the operation mode of the external on-board charger 210 is the mode for supplying power to the system power supply 10 or the mode for receiving power supplied from the system power supply 10 (S440). When all of the first to third terminals 111 to 113 are connected, the system power supply 10 may supply power to the external load 20 and supply power to the external on-board charger 210, or receive power from the external on-board charger 210. On the other hand, when the operation mode of the external on-board charger 210 is not the mode for supplying power to the system power supply 10 or the mode for receiving power supplied from the system power supply 10 (No in S440), the controller 120 is not able to supply and receive power through the external on-board charger 210 and thus may control the switch unit 115 such that the third terminal 113 is disconnected from the first terminal 111 and the second terminal 113 (S450).

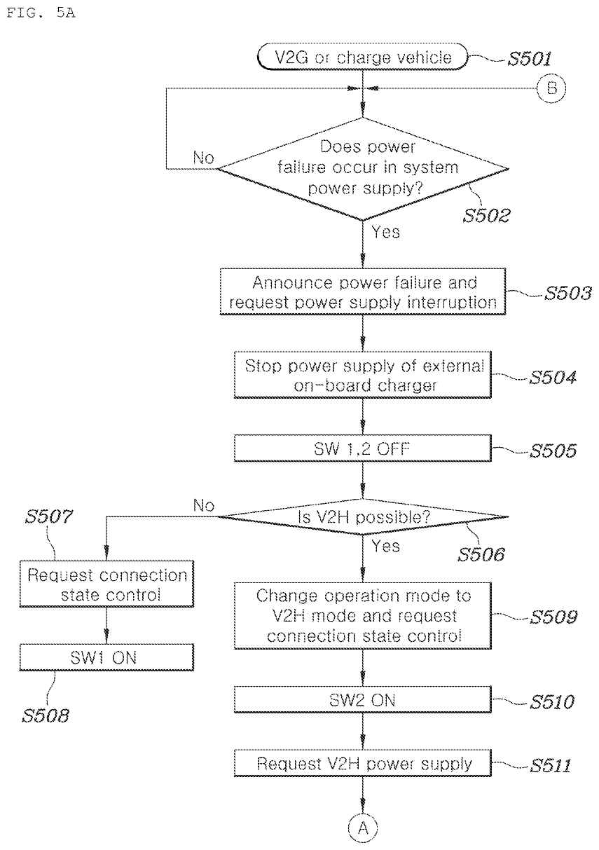

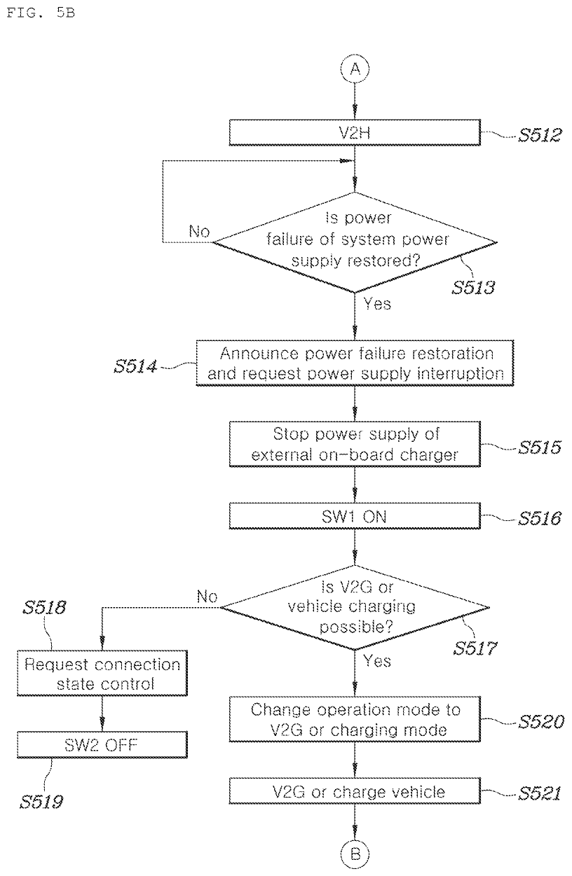

The operation of the charger has been described with reference to FIGS. 3 and 4, and the operation process of the charging system will be described below with reference to FIGS. 5A and 5B.

FIGS. 5A and 5B are diagrams for describing the operation process of the charging system according to an embodiment of the present disclosure. Hereinafter, the operation process of the charging system will be described on the assumption that the external on-board charger 210, the external charging controller 220, and the external battery 230 are implemented in an electric vehicle, and the external load 20 is an electrical load in a home.

Referring to FIGS. 5A and 5B, first, the controller 120 detects power failure of the system power supply (S502) in a state in which the first to third terminals 111 to 113 are connected to each other and thus power is supplied to the system power supply 10 from the electric vehicle (V2G) or the electric vehicle is charged with power supplied from the system power supply 10 (S501). When power failure of the system power supply 10 is detected (Yes in S502), the controller 120 may transmit power failure occurrence information to the external charging controller 220 through the communication device 130, and when the operation mode of the external on-board charger 210 is the mode for supplying power to the system power supply 10 (i.e., V2G), the controller 120 may request operation mode change such that power supply is stopped (S503). When the external charging controller 220 receives the operation mode change request, it changes the operation mode of the external on-board charger 210 such that power supply is stopped (S504).

When power supply from the external on-board charger 210 is stopped, the controller 120 turns off the first switch SW1 and the second switch SW2 such that connections between the first to third terminals 111 to 113 are released (S505). When both the first switch SW1 and the second switch SW2 are turned off, the external charging controller 220 determines whether the external on-board charger 210 can supply power the external load 20 (i.e., whether V2H is possible) (S506). If the external on-board charger 210 can supply power to the external load 20 (Yes in S506), the external charging controller 220 changes the operation mode of the external on-board charger 210 to the mode for supplying power to the external load 20 and requests that the controller 120 control the connection state of the switch unit 115 through the communication device 130 (S509). Upon reception of the request, the controller 120 turns on the second switch SW2 such that the second terminal 112 and the third terminal 113 are connected (S510) and requests power supply through the communication device 130 (S511). Thereafter, the external on-board charger 210 supplies power to the external load 20 (i.e., V2H) according to the request (S512). On the other hand, if it is determined that the external on-board charger 210 cannot supply power to the external load 20 (No in S506), the external charging controller 220 requests that the controller 120 stop control of the connection state of the switch unit 115 through the communication device 130 (S507), and the controller 120 that has received the request turns on the first switch SW1 such that power supply to the external load 20 is stopped until the power failure of the system power supply 10 is restored (S508).

When power failure restoration of the system power supply 10 is detected while the external on-board charger 210 supplies power to the external load 20 (i.e., V2H) (Yes in S513), the controller 120 transmits power failure restoration information to the external charging controller 220 through the communication device 130 and requests the external charging controller 220 stop power supply (S514). Upon reception of the request, the external charging controller 220 controls the external on-board charger 210 such that the external on-board charger 210 stops power supply (S515). In addition, the controller 120 turns on the first switch SW1 to connect the first to third terminals (S516) such that the external load 20 receives power from the system power supply 10, and the system power supply 10 and the external on-board charger 210 are connected to prepare for a V2G function or charging of the vehicle.

In the above state, the external charging controller 220 determines whether the external on-board charger 210 can supply power to the system power supply 10 or whether the external on-board charger 210 can receive power supplied from the system power supply 10 (S517). If it is determined that the external on-board charger 210 can supply or receive power (Yes of S517), the external charging controller 220 changes the operation mode of the external on-board charger 210 (S520) such that power can be supplied to the system power supply 10 (i.e., V2G) or the electric vehicle can be charged (S521). On the other hand, if it is determined that the external on-board charger 210 cannot supply or receive power (No in S517), the external charging controller 220 requests that the controller 120 control the connection state of the switch unit 115 through the communication device 130 (S518), and the controller 120 turns off the second switch SW2 to cut off the connection of the external on-board charger 210 to the system power supply 10 and the external load 20 (S519).

According to various embodiments of the present disclosure as described above, it is possible to effectively switch power supply methods in response to change in a power supply source or a power supply target.

In addition, it is possible to supply power through the external on-board charger in the event of power failure of the system power supply to effectively cope with the power failure, and it is possible to efficiently utilize power within a power system composed of various supply sources and supply targets.

In particular, by utilizing an existing on-board charger mounted on an electric vehicle, it is possible to improve the usability of the on-board charger and a vehicle including the same.

The effects that can be obtained in the present disclosure are not limited to the above-mentioned effects, and other effects which are not mentioned may be clearly understood by those of ordinary skill in the art to which the present disclosure belongs from the description below.

Although the preferred embodiments of the present disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. A charger comprising:
a junction box having a first terminal connected to a system power supply, a second terminal connected to an external load, a third terminal connected to an external on-board charger, and a switch unit configured to selectively connect at least two of the first to third terminals; and
a controller configured to control a connection state of the switch unit on the basis of whether power failure occurs in the system power supply and an operation mode of the external on-board charger.

2. The charger of claim 1, wherein the junction box receives AC power from the system power supply through the first terminal and supplies the AC power to at least one of the external load or the external on-board charger on the basis of the connection state of the switch unit, or receives AC power from the external on-board charger through the third terminal and supplies the AC power to at least one of the system power supply or the external load on the basis of the connection state of the switch unit.

3. The charger of claim 1, further comprising a communication device configured to communicate with an external charging controller connected to the external on-board charger,
wherein the controller receives an operation mode of the external on-board charger or a connection state change request corresponding to the operation mode from the external charging controller through the communication device, or requests that the external charging controller change the operation mode of the external on-board charger.

4. The charger of claim 3, wherein the controller controls the connection state of the switch unit such that the second terminal and the third terminal are connected to each other when power failure occurs in the system power supply.

5. The charger of claim 4, wherein the controller controls the connection state of the switch unit such that connections of the first to third terminals are all released when power failure occurs in the system power supply, and additionally controls the connection state of the switch unit such that the second terminal and the third terminal are connected when the operation mode of the external on-board charger is a mode for supplying power to the external load.

6. The charger of claim 5, wherein the controller additionally controls the connection state of the switch unit such that the first terminal and the second terminal are connected when the operation mode of the external on-board charger is not the mode for supplying power to the external load.

7. The charger of claim 4, wherein the controller requests that the external charging controller change the operation mode through the communication device such that the external on-board charger stops power supply when the operation mode of the external on-board charger is a mode for supplying power to the system power supply.

8. The charger of claim 4, wherein the controller requests that the external charging controller change the operation mode through the communication device such that the external on-board charger starts power supply when the second terminal and the third terminal are connected by controlling the connection state of the switch unit.

9. The charger of claim 3, wherein the controller controls the connection state of the switch unit such that the first terminal and the second terminal are connected at the time of restoring power failure of the system power supply.

10. The charger of claim 9, wherein the controller controls the connection state of the switch unit such that the first terminal and the third terminal are connected when the operation mode of the external on-board charger is a mode for supplying power to the system power supply or a mode for receiving power from the system power supply at the time of restoring the power failure of the system power supply.

11. The charger of claim 9, wherein the controller controls the connection state of the switch unit such that the first terminal and the third terminal are disconnected from each other when the operation mode of the external on-board charger does not correspond to any one of the mode for supplying power to the system power supply and the mode for receiving power from the system power supply during power failure restoration.

12. The charger of claim 9, wherein the controller requests that the external charging controller change the operation mode through the communication device such that the external on-board charger stops power supply when the operation mode of the external on-board charger is a mode for supplying power to the external load at the time of restoring the power failure of the system power supply.

13. The charger of claim 1, wherein the switch unit comprises:
a first switch; and
a second switch, and
wherein one end of the first switch is connected to the first terminal, the other end is connected to one end of the second switch, the other end of the second switch is connected to the third terminal, and the second terminal is connected between the other end of the first switch and one end of the second switch.

14. The charger of claim 1, further comprising:
a converter configured to convert AC power supplied through at least one of the first terminal or the third terminal into DC power; and
a battery configured to store the DC power converted through the converter,
wherein the junction box further comprises a fourth terminal connected to the converter and selectively connects at least two of the first to fourth terminals.

15. A charging system comprising:
an external on-board charger configured to supply power to a system power supply or to receive power from the system power supply;
an external charging controller configured to control the external on-board charger; and
a charger comprising a junction box having a first terminal connected to a system power supply, a second terminal connected to an external load, a third terminal connected to the external on-board charger, and a switch unit configured to selectively connect at least two of the first to third terminals, and a controller configured to control a connection state of the switch unit on the basis of whether power failure occurs in the system power supply and an operation mode of the external on-board charger.

16. The charging system of claim 15, wherein the charger further comprises a communication device configured to communicate with the external charging controller,
wherein the controller receives an operation mode of the external on-board charger from the external charging controller through the communication device, or requests that the external charging controller change the operation mode of the external on-board charger.

17. The charging system of claim 16, wherein the external charging controller determines at least one of whether the external on-board charger is able to supply power to the external load, whether the external on-board charger is able to supply power to the system power supply, or whether the external on-board charger is able to receive power from the system power supply when preset conditions are satisfied, and controls the operation mode of the external on-board charger to be changed on the basis of a determination result.

18. The charging system of claim 17, wherein, when the operation mode of the external on-board charger is changed, the external charging controller transmits the changed operation mode of the external on-board charger to the controller through the communication device or requests switch connection state control corresponding to the changed operation mode.

19. The charging system of claim 17, wherein the external charging controller determines whether power is able to be supplied to the external load or the system power supply on the basis of at least one of a state of charge (Sac) of an external battery connected to the external on-board charger or whether the external on-board charger normally operates.

20. The charging system of claim 15, wherein, when the operation mode is a mode for supplying power to the system power supply or a mode for receiving power from the system power supply, the external charging controller performs output current and phase control through the external on-board charger to correspond to the system power supply, and when the operation mode is a mode for supplying power to the external load, the external charging controller performs voltage and frequency control through the external on-board charger to correspond to the external load.
